(19) United States
(12) Patent Application Publication
(10) Pub. No.: US 2023/0097311 A1
(43) Pub. Date: Mar. 30, 2023

(54) WORK ASSIGNMENT INTEGRATION

(71) Applicant: Avaya Management L.P., Durham, NC (US)

(72) Inventors: Stephen D. Smith, Bluffdale, UT (US); Stephen Millan, Phoenix, AZ (US)

(21) Appl. No.: 17/488,133

(22) Filed: Sep. 28, 2021

(51) Int. Cl. H04M 3/527; H04M 3/523; G06N 5/04

(52) U.S. Cl. CPC H04M 3/527; H04M 3/5233; G06N 5/04

(57) ABSTRACT

Contact centers often simultaneously utilize two or more entities for making routing decisions to match a caller with an agent. The entities utilize discrete methodologies, such as algorithmic versus artificial intelligence (AI) based decision making. Algorithmic decision-making components provide robustness and ensuring the very best match, of all possible matches, is made. AI-based decision making provides a decision based on learning/training and is often faster. The decisions reached are expected to be identical. However, the management and data reporting from two very different systems can produce errors and increase overhead. Accordingly, a management component is provided to harmonize the inputs and outputs of these disparate systems to comport to a single standard.

### FIELD OF THE DISCLOSURE

The invention relates generally to systems and methods for disparate system harmonization and particularly to managing disparate systems providing decision inputs into a networking system.

### BACKGROUND

In a queue-based automatic call director (ACD) system, calls are typically delivered to, and serviced by, the ACD wherein an external resource's Artificial Intelligence (AI) behavior pairing can be used. In other solutions, prior to selecting the agent, an external call distribution feature queries an external party resource, such as an AI, for the agent selection decision. The external-party resource determines whether to pair a caller with the agent or to allow the ACD to process the call. There are a series of checks used to determine agent selection eligibility. The external party resource utilizes a decision-making process, such as an AI, different from the ACD algorithms in order to route the call. When, the external party defers agent selection to the ACD, it utilizes a baseline predicated upon a generic first-in first-out (FIFO) operation. Therefore, when comparing the external party resource versus the native ACD routing, the external party's behavioral pairing appears better because of the simplified baseline, as opposed to the robust algorithms used by the ACD.

### SUMMARY

Two high-level decision paradigms are common in many call centers. These paradigms determine which particular human agent or AI agent, rather than a human agent, will be paired with a particular user to resolve a work item. One paradigm is a work assignment algorithm that provides an algorithmic methodology of the ACD, and the other relies on an external system to provide behavioral paring, such as via an AI-based decision engine.

Generally, the embodiments herein are directed to systems and methods to provide a clear delineation of the two different routing paradigms and to further provide greater control of the external party behavioral pairing (or AI agent selection) and algorithm selection, consistent analytics, and administration. During the pre-queue phase, that is prior to ACD call receipt, the call center is configured as to which paradigm will be used to route calls. For example, within a given interval of time (typically 30 minutes), the external party resource provides routing instructions 80% of the time and the ACD handles the remaining 20%.

The ACD systems utilize one set of reporting and management systems and data structures for presenting reports, events, errors, etc. Using external party systems requires another system to duplicate the systems and processing required from ACD-based systems alone. Typically, external systems make reporting issues and customers (e.g., enterprises that are, or utilize, the contact center to service their customers) either “live with” dissimilar systems performing the same functions or require manual adjustments to harmonize the data.

Embodiments herein include systems and methods to natively integrate external resources with those internal to a contact center system, when different from the external resource, using the same criteria used by a work assignment engine to publish clean data results, thus improving customer and agent matching without sacrificing reporting.

These and other needs are addressed by the various embodiments and configurations of the present invention. The present invention can provide a number of advantages depending on the particular configuration. These and other advantages will be apparent from the disclosure of the invention(s) contained herein.

Behavioral pairing is matching of interactions based on a variety of factors using Artificial Intelligence (AI). Factors may include personality matching, psychographic data, customer resource management (CRM) data, historic information, and/or other data. the AI uses these factors to pair a caller (or callee, in the case of outbound calls) with an agent having a particular profile to drive a particular business outcome for an interaction. The selected agent may have a personality or other attributes similar to that of the caller/callee (e.g., expressions, background, language(s) spoken, etc.) or dissimilar (e.g., male-female, New Englander-Southern, aggressive-patient, etc.). The pairing selected is designed to improve aspects of the call, such as the customer experience, retention, revenue generation, sales, shorten time on the call to resolve an issue, reduce or eliminate the need for subsequent calls, reduce or eliminate the need to include other resources (e.g., experts, managers, etc.) on the call. Agents selected may be specific agents or a group (e.g., queue) of agents, each having similar attributes or skills necessary to resolve a work item of the call. If a group is selected, the user is connected to a next available agent of the group.

The two selection paradigms (e.g., attribute matching and behavioral pairing) are not the same and have traditionally been mutually exclusive. Behavioral pairing has been used primarily in a skills-based environment, wherein one concept described herein is to marry behavioral pairing and attribute matching to provide a seamless, improved attribute model that is utilized in one system instead of two. Attribute matching and behavioral pairing are discrete paradigms that are difficult to integrate together. Behavior pairing relies on AI, such as a trained neural network, that can be incompatible with algorithmic decisions, such as those from attribute matching and vice versa. Integration of the two paradigms often produces greatly skewed results in unexpected or undesirable ways. In the case of AI-based systems, which are often continually evaluating decisions and their results for self-training, corrupts subsequent decisions. Therefore, the two paradigms are maintained as separate entities (e.g., enterprises, programs, modules, etc.).

When a request for an agent resource is received, the work assignment engine (WAE) itself would not respond initially. Instead, behavioral pairing can be executed with the parameters used in the request and then respond, mimicking a typical work attribute matching assignment response, so that downstream systems would report on the resource assignment in the same fashion regardless of whether behavioral pairing or work assignment agent selection were utilized. As a benefit of the embodiments disclosed herein, administration is improved as the same types of values are used for agent assignment, for both paradigms, while providing metric consistency of all responses. In the event that the external resource does not respond or defers agent selection, WAE will be queried for a response using the parameters of the agent selection request.

One reason for the native integration is that when an external system (e.g., an external behavioral pairing system) is integrated, operational management of a contact center is disrupted. For example, a number of agents may be inadvertently idle while others are overallocated. Calls may be left in queue for unnecessarily long periods of time while resources are available to connect to the call and resolve the work item. In particular, data reporting that feeds into systems that automatically adjust the networking resources to alter the topology of the system may be misconfigured resulting in dropped connections or poor-quality connections while portions of the topology may have an excessive amount of spare capacity. Further management of agents and scheduling/forecasting is skewed, performance metrics are affected, etc. All data is impacted when the AI chooses agents rather than the native contact center system. The use of native integration preserves all of the downstream data integrity.

As another benefit of the embodiments provided herein, there is a reduced dependency upon specific products, such as a Business Rules Engine (BRE), and instead abstract the agent selection mechanism(s) so as to have a generic-appearing set of features for administration, agent selection, and data reporting.

In one embodiment, business rules for routing selection collects the attributes of the interaction request. At least two destinations (e.g., attribute matching and behavioral pairing) are configured in a module, such as the business rules engine logic. Optionally, one rule can be an on/off flag to exclude one destination (e.g., behavioral pairing) from consideration as a destination. Otherwise, the same attributes are delivered to/passed on to either a work assignment module (using attribute matching) or an external resource (using behavioral pairing), each of which utilize the same event stream (e.g., event bus), and take in and output the same data. It is expected, although not necessary, for the output from each paradigm to be the same, as they are each provided with the same inputs. It is the speed and logic utilized to arrive at the common output that differs. The output is then presented to downstream systems to perform the routing, connecting, event logging, reporting, analytics, and/or other services to connect the caller to the selected agent.

In another embodiment, work assignment, which may be a stand-alone or integrated module or application programming interface (API), provides real-time event reporting, such as agents' states via publication and/or subscription to presence information, administration interface for profile management, and metrics for agent pairing decisions.

In another embodiment, behavior pairing, which may be provided by an internal or external resource discrete from the work assignment module or mechanism, may subscribe to agent state events, synchronize with administrative API for profile management and attribute consistency, query a metrics API for attribute service EWT, agents staffed/available, and/or other conditions of a contact center. When the behavioral pairing pairs an agent to a caller (or callee if outbound) the pairing is written to an eventing framework (e.g., system, module, etc. for receiving events and providing processed outputs from the events) identifying the agent (e.g., agent ID) and an attribute service map, and data that is similar and expectedly identical to the data provided by the work assignment module to the eventing framework.

Exemplary aspects are directed to:

A method for configuring multiple decision components of a system utilized to match specific users of a number of users to a specific agent of a number of agents, comprising: receiving, by a processor, a raw modification data structure comprising an attribute utilized by each of a first decision component and a second decision component, each being a portion of the multiple decision components; determining, by the processor, a first mapping of the attribute to a command of the first decision component; generating, by the processor, a first modified data structure from the first mapping; providing, by the processor, the first modified data structure to the first decision component, to cause at least at least one user of the specific users to be matched to a different specific agent of the number of agents as compared to a match that would have occurred prior to providing the first modified data structure to the first decision component; determining, by the processor, a second mapping of the attribute to a command of the second decision component; generating, by the processor, a second modified data structure from the second mapping; and providing, by the processor, the second modified data structure to the second decision component, to cause at least one user of the specific users to be matched to a different specific agent of the number of agents as compared to a match that would have occurred prior to providing the second modified data structure to the second decision component.

A system for configuring multiple decision components of a system utilized to match specific users of a number of users to a specific agent of a number of agents, comprising: a processor, comprising at least one microprocessors having instructions maintained in a non-transitory memory for execution by the processor; an interface to a network; and wherein the processor: receives a raw modification data structure comprising an attribute utilized by each of a first decision component and a second decision component, each being a portion of the multiple decision components; determines, a first mapping of the attribute to a command of the first decision component; generates a first modified data structure from the first mapping; provides the first modified data structure to the first decision component, to cause at least at least one user of the specific users to be matched to a different specific agent of the number of agents as compared to a match that would have occurred prior to providing the first modified data structure to the first decision component; determines a second mapping of the attribute to a command of the second decision component; generates a second modified data structure from the second mapping; and provides the second modified data structure to the second decision component, to cause at least at least one user of the specific users to be matched to a different specific agent of the number of agents as compared to a match that would have occurred prior to providing the second modified data structure to the second decision component.

A system for configuring multiple decision components of a system utilized to match specific users of a number of users to a specific agent of a number of agents, comprising: means to receive a raw modification data structure comprising an attribute utilized by each of a first decision component and a second decision component, each being a portion of the multiple decision components; means to determine a first mapping of the attribute to a command of the first decision component; means to generate a first modified data structure from the first mapping; means to provide the first modified data structure to the first decision component, to cause at least at least one user of the specific users to be matched to a different specific agent of the number of agents as compared to a match that would have occurred prior to providing the first modified data structure to the first decision component; means to determine a second mapping of the attribute to a command of the second decision component; means to generate a second modified data structure from the second mapping; and means to provide the second modified data structure to the second decision component, to cause at least at least one user of the specific users to be matched to a different specific agent of the number of agents as compared to a match that would have occurred prior to providing the second modified data structure to the second decision component.

Any of the above aspects:

Further comprising receiving, by the processor, a communication via a network of a first user of the number of users; obtaining attributes of at least one of the first user and a reason for the communication; providing the attributes to a selected one of the first decision component or the second decision component; receiving from the selected one of the first decision component or the second decision component, a matching decision selecting a first agent of the number of agents; and altering, by the processor, a network topology to connect a communication device associated with the first agent to a user device utilized by the first user for communication via the network.

Further comprising receiving, by the processor and from the first decision component, a first record comprising an analytic data structure comprising a rationale utilized in determining the matching decision from the selected one of the first decision component or the second decision component providing the matching decision.

Further comprising, upon the selected one of the first decision component or the second decision component being the first decision component, generating, by the processor, the second modified data structure to further comprise the rationale.

Further comprising, upon the selected one of the first decision component or the second decision component being the second decision component, generating, by the processor, the first modified data structure to further comprise the rationale.

Wherein the analytic data structure comprises at least one field indicating at least one of an error, an event, or an aggregated event report.

Wherein providing the attributes to the selected one of the first decision component or the second decision component, further comprises providing the attributes to both the first decision component and the second decision component; and receiving from the selected one of the first decision component or the second decision component, the matching decision selecting a first agent of the number of agents, further comprises receiving the matching decision from the first decision component or the second decision component that is first to respond with the matching decision.

Wherein the agent is an automated agent.

Wherein the agent is an agent queue for a set of agents.

A system on a chip (SoC) including any one or more of the above aspects.

One or more means for performing any one or more of the above aspects.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

Any of the above embodiments or aspects, wherein the data storage comprises a non-transitory storage device comprise at least one of: an on-chip memory within the processor, a register of the processor, an on-board memory co-located on a processing board with the processor, a memory accessible to the processor via a bus, a magnetic media, an optical media, a solid-state media, an input-output buffer, a memory of an input-output component in communication with the processor, a network communication buffer, and a networked component in communication with the processor via a network interface.

It is to be appreciated that any feature described herein can be claimed in combination with any other feature(s) as described herein, regardless of whether the features come from the same described embodiment.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible, non-transitory medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below. Also, while the disclosure is presented in terms of exemplary embodiments, it should be appreciated that an individual aspect of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a second system in accordance with embodiments of the present disclosure;

FIG. 3 depicts a third system in accordance with embodiments of the present disclosure;

FIG. 4 depicts a first process in accordance with embodiments of the present disclosure;

FIG. 5 depicts a second process in accordance with embodiments of the present disclosure;

FIG. 6 depicts a third process in accordance with embodiments of the present disclosure;

FIG. 7 depicts a fourth system in accordance with embodiments of the present disclosure;

FIG. 8 depicts a fifth system in accordance with embodiments of the present disclosure; and

FIG. 9 depicts a raw data structure and modified data structure in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising a numeric reference number, without an alphabetic sub-reference identifier when a sub-reference identifier exists in the figures, when used in the plural, is a reference to any two or more elements with a like reference number. When such a reference is made in the singular form, but without identification of the sub-reference identifier, is a reference to one of the like numbered elements, but without limitation as to the particular one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

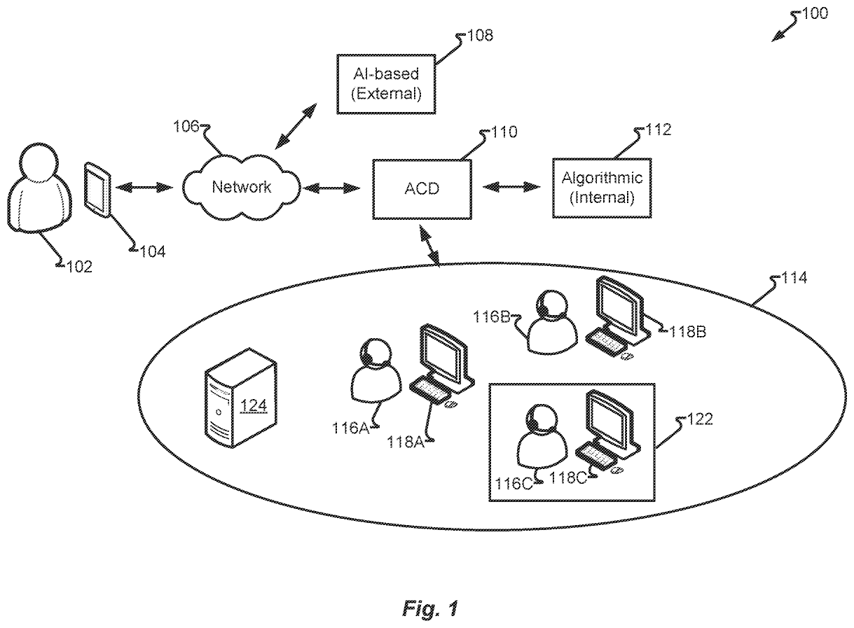

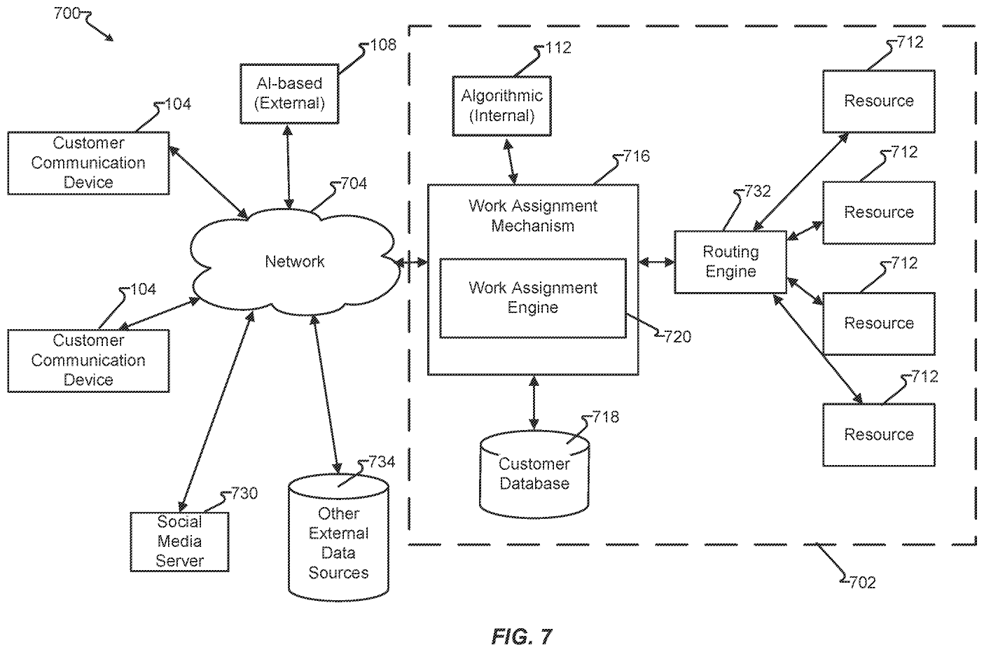

FIG. 1 depicts system 100 in accordance with embodiments of the present disclosure. In one embodiment, user 102 utilizes AI-based decision component 108 to initiate communication via network 106 and comprising nodes of a contact center (see FIG. 7), such as automatic call director 110. In another embodiment, automatic call director 110, and or other component, initiates a communication with user 102 via user communication device 104 and utilizing network 106. A specific agent of agent pool 114 is required to join the call and once selected, a network topology includes AI-based decision component 108 and at least one agent communication device 118, if a corresponding agent 116 is selected or, if an automated agent is selected, automated agent 124. While a call (i.e., an audio-only communication) is discussed, it should be appreciated that in other embodiments other real-time communications (e.g., video), near-real time communications (e.g., text chat, social media post/replies, etc.) and/or non-real time communications (e.g., email), may be utilized without departing from the scope of the embodiments.

Automatic call director 110 may utilize either algorithmic-based decision component 112 or AI-based decision component 108 in order to obtain a routing decision, and then routes the call accordingly. The decision as to which of AI-based decision component 108 or algorithmic-based decision component 112 to utilize may be based on a fixed allocation (e.g., 80% to AI-based decision component 108 and 20% algorithmic-based decision component 112), first to respond, or other selection means. Automatic call director 110 provides attributes of the call such as caller attribute(s), attribute(s) of user communication device 104, a known or suspected reason or topic of the call, geographic attribute(s) of user 102, prior history with user 102, and/or other features known or suspected to be inputs into a routing decision made by AI-based decision component 108 or algorithmic-based decision component 112. The result is returned from AI-based decision component 108 and/or algorithmic-based decision component 112 to designate a specific agent (e.g., a particular one of agent 116), a queue for a specific group of agents, or an automated agent (e.g., automated agent 124).

The decisions provided by each of AI-based decision component 108 and algorithmic-based decision component 112 are identical, absent error. However, the configurations and reporting data structures are different for each. As a result, errors may occur when the same configuration is expected to be applied to both AI-based decision component 108 and algorithmic-based decision component 112 due to different data structures, formatting, or other configuration inputs. Accordingly, embodiments herein allow for a single configuration input to produce specific configurations for each of AI-based decision component 108 and algorithmic-based decision component 112. Embodiments are also provided to allow reporting received from each of AI-based decision component 108 and algorithmic-based decision component 112 to be harmonized into a unified report.

While the embodiments herein differentiate the decision making components as AI-based decision component 108 (an external component to a contact center), and algorithmic-based decision component 112 (an internal component to the contact center), in other embodiments, both components may be internal, external, or the role of the components may be different, such as both are differently trained AI or both are differently programmed algorithms, etc., without departing from the scope of the embodiments herein.

With a decision received at automatic call director 110, a particular agent, automated agent, or pool of agents is selected. For example, selected agent 122 comprising agent 116C utilizing agent communication device 118C to communicate with user 102 utilizing communication device 104 via network 106. Metrics may be captured (e.g., length of the call, emotion, sentiment, etc.) and provided as feedback to one or more of automatic call director 110, AI-based decision component 108, algorithmic-based decision component 112, and/or other components for use in guiding future agent selection decisions.

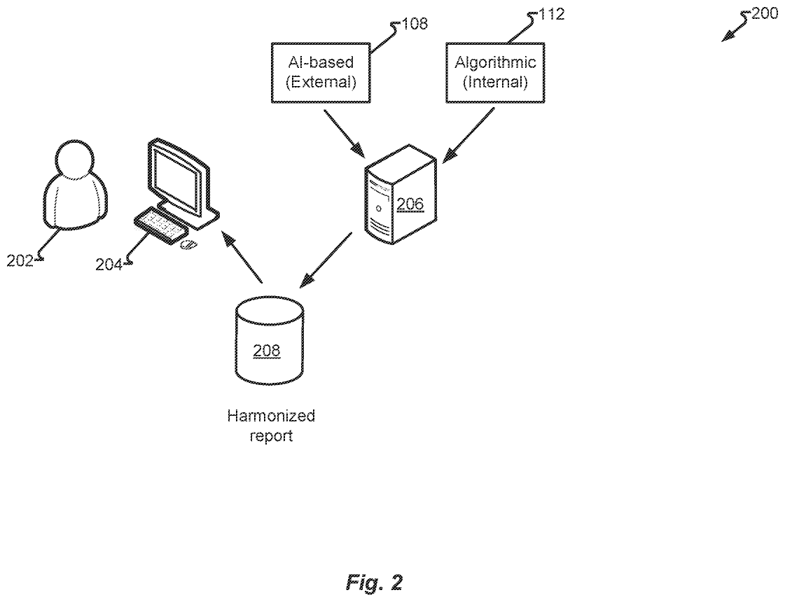

FIG. 2 depicts system 200 in accordance with embodiments of the present disclosure. In one embodiment, each of AI-based decision component 108 and algorithmic-based decision component 112 provide reporting data structures (e.g., events, errors, status, etc.) to server 206. Server 206 maps the individual fields, data format, etc. to a common data structure, such as a data structure utilized by algorithmic-based decision component 112 and/or a third data structure. If a third data structure is utilized, then data elements and data structures provided from algorithmic-based decision component 112 are similarly mapped to a common format, from which server 206 writes the common data format to harmonized report storage 208. In one embodiment, administrator 202 utilizing administrator device 204. In another embodiment, other components, such as those utilized to automatically configure one or both of AI-based decision component 108 and algorithmic-based decision component 112, read the data structures maintained in harmonized report storage 208 and, from the values therein, perform configurations and/or alterations to one or both of AI-based decision component 108 and algorithmic-based decision component 112 to maintain the functionality thereof.

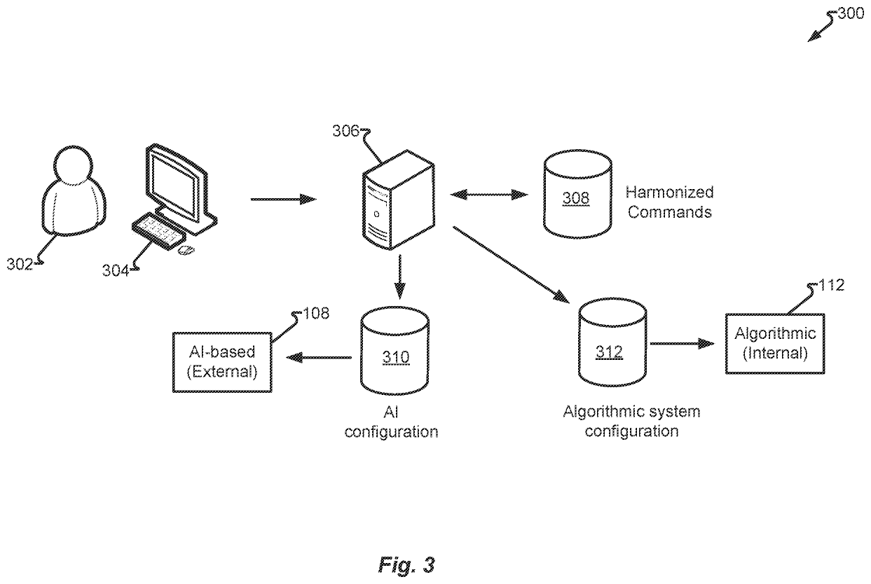

FIG. 3 depicts system 300 in accordance with embodiments of the present disclosure. In one embodiment, administrator 302 utilizes administrator device 304 to issue configuration commands, such as to input known future events or provide manual inputs to improve functionality. The future events may be planned maintenance whereby assumptions about agents available will become invalid for a period of time and routing to such agents will produce errors or degrade operations (e.g., increase wait times, cause calls to be routed to less qualified agents, etc.).

Server 306 receives the configuration in a single, standard format from administrator device 304. The standard format may be that defined by algorithmic-based decision component 112 or a third format not natively common to either AI-based decision component 108 or algorithmic-based decision component 112. Server 306 may map harmonized commands to commands specific to each of AI-based decision component 108 and algorithmic-based decision component 112 based on rules, which may be maintained in harmonized commands storage 308. Server 306 then provides the commands to each of AI system configuration storage 310 and algorithmic system configuration storage 312 whereby AI-based decision component 108 and algorithmic-based decision component 112, respectively, read the commands and carry out the configurations therein.

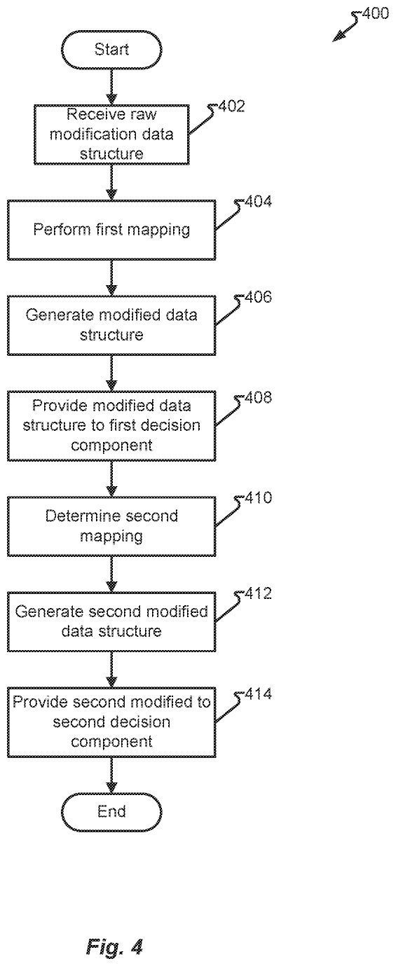

FIG. 4 depicts process 400 in accordance with embodiments of the present disclosure. In one embodiment, process 400 is embodied as machine-readable instructions maintained in a non-transitory memory and when read by a processor, cause the processor to execute the steps of process 400. In one embodiment, process 400 receives a single data structure to modify each of AI-based decision component 108 and algorithmic-based decision component 112 to alter the operations thereof each requiring configurations in different data structures.

Process 400 begins and step 402 receives a raw modification data structure, such as by administrator device 304 operated by administrator 302. Step 404 performs a first mapping wherein one or more of values, formats, or data elements from the raw modification data structure are mapped to elements associated with a first data component, such as AI-based decision component 108 or algorithmic-based decision component 112. With the mapping, step 406 generates a modified data structure which is provided to the first decision component in step 408.

Step 410 performs a second mapping wherein one or more of values, formats, or data elements from the raw modification data structure are mapped to elements associated with a second data component, such as the other of AI-based decision component 108 or algorithmic-based decision component 112. With the mapping, step 412 generates a modified data structure which is provided to the first decision component in step 414.

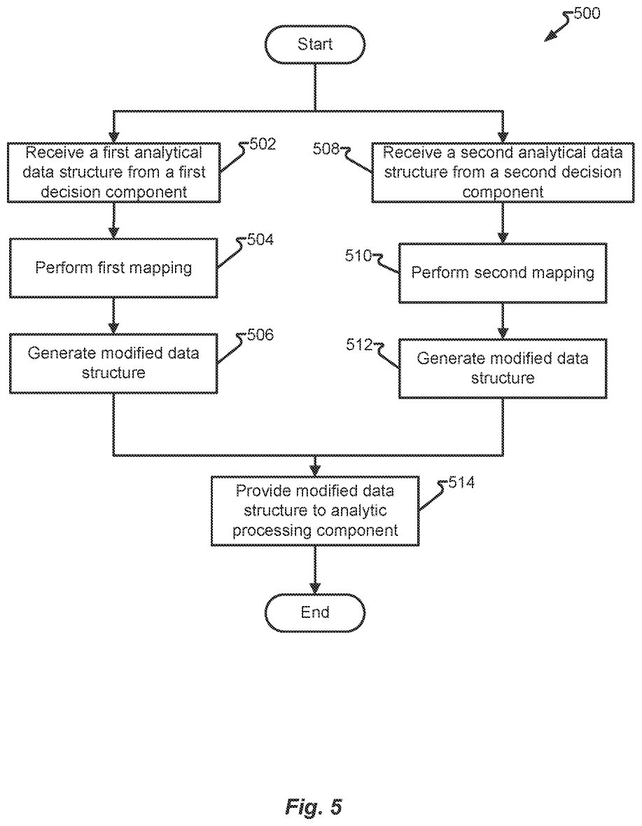

FIG. 5 depicts process 500 in accordance with embodiments of the present disclosure. In one embodiment, process 500 is embodied as machine-readable instructions maintained in a non-transitory memory and when read by a processor, cause the processor to execute the steps of process 500. In one embodiment, a unified data structure is created from inputs from each of AI-based decision component 108 and algorithmic-based decision component 112 comprising dissimilar data structures.

Step 502 receives a first analytical data structure, such as comprising events, errors, operations, changes, etc., such as from one of AI-based decision component 108 or algorithmic-based decision component 112. Step 504 performs a first mapping of the first analytical data structure to equivalent data structures associated with a modified data structure. Step 506 then generates the modified data structure from the first analytical data structure as mapped. The modified data structure is then provided to an analytic component in step 514.

Step 508 receives a second analytical data structure, such as comprising events, errors, operations, changes, etc., such as from the other of AI-based decision component 108 or algorithmic-based decision component 112. Step 510 performs a second mapping of the second analytical data structure to equivalent data structures associated with a modified data structure. Step 512 then generates the modified data structure from the second analytical data structure as mapped. The modified data structure is then provided to an analytic component in step 514

Embodiments of process 500 include executing steps 502-506 separately (e.g., in series) from the execution of steps 508-512. In other embodiments, some of steps 502-506 may be executed concurrently or interspersed, in whole or in part, with the execution of steps 508-512.

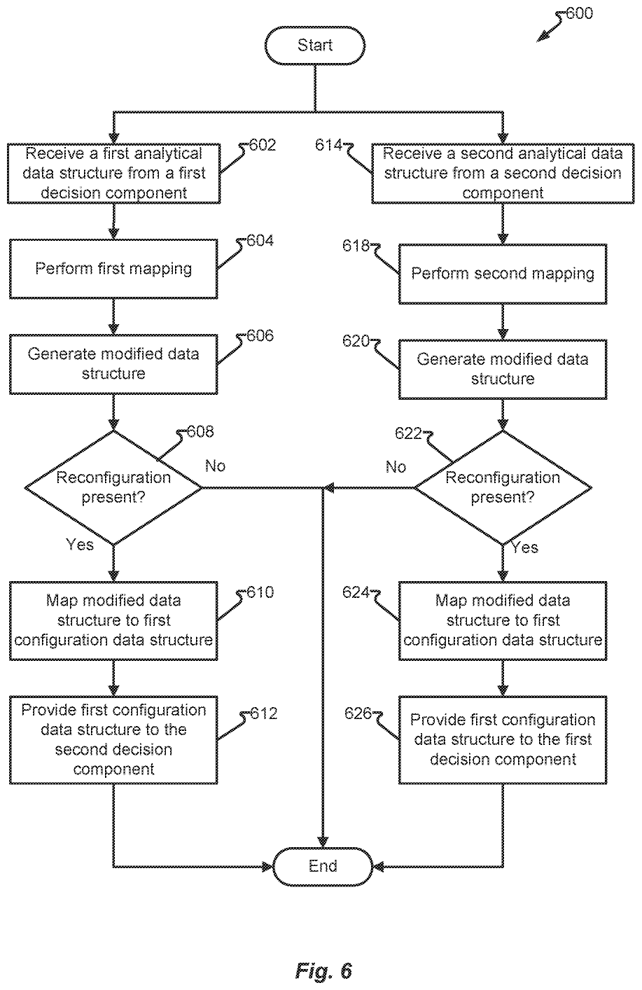

FIG. 6 depicts process 600 in accordance with embodiments of the present disclosure. In one embodiment, process 600 is embodied as machine-readable instructions maintained in a non-transitory memory and when read by a processor, cause the processor to execute the steps of process 600. In one embodiment, process 600 allows for one decision component to configure the other decision component, such as AI-based decision component 108 configuring algorithmic-based decision component 112 or vice versa.

Process 600 begins and step 602 receives a first analytical data structure from a first data decision component, such as one of AI-based decision component 108 or algorithmic-based decision component 112. Step 604 performs a first mapping wherein the first analytical data structure is mapped to a modified data structure, such as a data structure associated with the other of AI-based decision component 108 or algorithmic-based decision component 112. The analytical data structure may include one or more of operations performed, errors, exceptions, etc. Step 606 then generates the modified data structure from the first analytical data structure as modified by mappings of step 604.

If test 608 determines that no reconfiguration is present in the modified data structure, process 600 may end or, in another embodiment, loop back to the start. If test 608 is determined in the affirmative, processing continues to step 610 wherein the modified data structure of step 606 is mapped to a first configuration data structure and, in step 612, is provided to the second decision component, such as the other of AI-based decision component 108 or algorithmic-based decision component 112.

Step 614 receives a second analytical data structure from a second data decision component, such as the other (as compared to the first decision entity of step 602) of AI-based decision component 108 or algorithmic-based decision component 112. Step 618 performs a second mapping wherein the second analytical data structure is mapped to a modified data structure, such as a data structure associated with the first of AI-based decision component 108 or algorithmic-based decision component 112 (such as the first decision entity of step 602). The analytical data structure may include one or more of operations performed, errors, exceptions, etc. Step 620 then generates the modified data structure from the first analytical data structure as modified by mappings of step 618.

If test 622 determines that no reconfiguration is present in the modified data structure, process 600 may end or, in another embodiment, loop back to the start. If test 622 is determined in the affirmative, processing continues to step 624 wherein the modified data structure of step 620 is mapped to a second configuration data structure and, in step 626, is provided to the first decision component, such as the other of AI-based decision component 108 or algorithmic-based decision component 112.

Embodiments of process 600 include executing steps 602-612 separately (e.g., in series) from the execution of steps 614-626. In other embodiments, some of steps 602-612 may be executed concurrently or interspersed, in whole or in part, with the execution of steps 602-612.

FIG. 7 depicts system 700 in accordance with at least some embodiments of the present disclosure. The communication system 700 may be a distributed system and, in some embodiments, comprises a communication network 704 connecting one or more customer communication devices 104 to a work assignment mechanism 716, which may be owned and operated by an enterprise administering contact center 702 in which a plurality of resources 712 is distributed to handle incoming work items (in the form of contacts) from customer communication devices 104. In one embodiment, work assignment mechanism may be, comprise, or be comprised by automatic call director 110.

Contact center 702 is variously embodied to receive and/or send messages that are, or are associated with, work items and the processing and management (e.g., scheduling, assigning, routing, generating, accounting, receiving, monitoring, reviewing, etc.) of the work items by one or more resources 712. The work items are generally generated and/or received requests for a processing resource 712 embodied as, or a component of, an electronic and/or electromagnetically conveyed message. Contact center 702 may include more or fewer components than illustrated and/or provide more or fewer services than illustrated. The border indicating contact center 702 may be a physical boundary (e.g., a building, campus, etc.), legal boundary (e.g., company, enterprise, etc.), and/or logical boundary (e.g., resources 712 utilized to provide services to customers for a customer of contact center 702).

Furthermore, the border illustrating contact center 702 may be as-illustrated or, in other embodiments, include alterations and/or more and/or fewer components than illustrated. For example, in other embodiments, one or more of resources 712, customer database 718, and/or other component may connect to routing engine 732 via communication network 704, such as when such components connect via a public network (e.g., Internet). In another embodiment, communication network 704 may be a private utilization of, at least in part, a public network (e.g., VPN); a private network located, at least partially, within contact center 702; or a mixture of private and public networks that may be utilized to provide electronic communication of components described herein. Additionally, it should be appreciated that components illustrated as external, such as social media server 730 and/or other external data sources 734, may be within contact center 702 physically and/or logically, but still be considered external for other purposes. For example, contact center 702 may operate social media server 730 (e.g., a website operable to receive user messages from customers and/or resources 712) as one means to interact with customers via their customer communication device 104.

Customer communication devices 104 are embodied as external to contact center 702 as they are under the more direct control of their respective user or customer. However, embodiments may be provided whereby one or more customer communication devices 104 are physically and/or logically located within contact center 702 and are still considered external to contact center 702, such as when a customer utilizes customer communication device 104 at a kiosk and attaches to a private network of contact center 702 (e.g., Wi-Fi connection to a kiosk, etc.), within or controlled by contact center 702.

It should be appreciated that the description of contact center 702 provides at least one embodiment whereby the following embodiments may be more readily understood without limiting such embodiments. Contact center 702 may be further altered, added to, and/or subtracted from without departing from the scope of any embodiment described herein and without limiting the scope of the embodiments or claims, except as expressly provided.

Additionally, contact center 702 may incorporate and/or utilize social media server 730 and/or other external data sources 734 may be utilized to provide one means for a resource 712 to receive and/or retrieve contacts and connect to a customer of a contact center 702. Other external data sources 734 may include data sources, such as service bureaus, third-party data providers (e.g., credit agencies, public and/or private records, etc.). Customers may utilize their respective customer communication device 104 to send/receive communications utilizing social media server 730.

In accordance with at least some embodiments of the present disclosure, the communication network 704 may comprise any type of known communication medium or collection of communication media and may use any type of protocols to transport electronic messages between endpoints. The communication network 704 may include wired and/or wireless communication technologies. The Internet is an example of the communication network 704 that constitutes an Internet Protocol (IP) network consisting of many computers, computing networks, and other communication devices located all over the world, which are connected through many telephone systems and other means. Other examples of the communication network 704 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a Voice over IP (VoIP) network, a cellular network, and any other type of packet-switched or circuit-switched network known in the art. In addition, it can be appreciated that the communication network 704 need not be limited to any one network type and instead may be comprised of a number of different networks and/or network types. As one example, embodiments of the present disclosure may be utilized to increase the efficiency of a grid-based contact center 702. Examples of a grid-based contact center 702 are more fully described in U.S. Patent Publication No. 2010/0296417 to Steiner, the entire contents of which are hereby incorporated herein by reference. Moreover, the communication network 704 may comprise a number of different communication media, such as coaxial cable, copper cable/wire, fiber-optic cable, antennas for transmitting/receiving wireless messages, and combinations thereof.

The customer communication devices 104 may correspond to customer communication devices. In accordance with at least some embodiments of the present disclosure, a customer may utilize their customer communication device 104 to initiate a work item. Illustrative work items include, but are not limited to, a contact directed toward and received at a contact center 702, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 704. For example, the work item may be transmitted as a telephone call, a packet or collection of packets (e.g., IP packets transmitted over an IP network), an email message, an Instant Message, an SMS message, a fax, and combinations thereof. In some embodiments, the communication may not necessarily be directed at the work assignment mechanism 716, but rather may be on some other server in the communication network 704 where it is harvested by the work assignment mechanism 716, which generates a work item for the harvested communication, such as social media server 730. An example of such a harvested communication includes a social media communication that is harvested by the work assignment mechanism 716 from a social media server 730 or network of servers. Exemplary architectures for harvesting social media communications and generating work items based thereon are described in U.S. patent application Ser. Nos. 12/784,369, 12/706,942, and 12/707,277, filed Mar. 20, 2010, Feb. 17, 2010, and Feb. 17, 2010, respectively; each of which is hereby incorporated herein by reference in its entirety.

The format of the work item may depend upon the capabilities of the customer communication device 104 and the format of the communication. In particular, work items are logical representations within a contact center 702 of work to be performed in connection with servicing a communication received at contact center 702 (and, more specifically, the work assignment mechanism 716). The communication may be received and maintained at the work assignment mechanism 716, a switch or server connected to the work assignment mechanism 716, or the like, until a resource 712 is assigned to the work item representing that communication. At which point, the work assignment mechanism 716 passes the work item to a routing engine 732 to connect the customer communication device 104, which initiated the communication, with the assigned resource 712. Work assignment mechanism 716 may utilize the particular resource 712 (e.g., agent 116, pool of agents 116, or automated agent 124).

Work assignment mechanism 716 or other component may provide attributes of the communication to one or both of AI-based decision component 108 or algorithmic-based decision component 112 to receive a routing decision therefrom and executed by routing engine 732.

Although the routing engine 732 is depicted as being separate from the work assignment mechanism 716, the routing engine 732 may be incorporated into the work assignment mechanism 716 or its functionality may be executed by the work assignment engine 720.

In accordance with at least some embodiments of the present disclosure, the customer communication devices 104 may comprise any type of known communication equipment or collection of communication equipment. Examples of a suitable customer communication device 104 include, but are not limited to, a personal computer, laptop, Personal Digital Assistant (PDA), cellular phone, smart phone, telephone, or combinations thereof. In general, each customer communication device 104 may be adapted to support video, audio, text, and/or data communications with other customer communication devices 104 as well as the processing resources 712. The type of medium used by the customer communication device 104 to communicate with other customer communication devices 104 or processing resources 712 may depend upon the communication applications available on the customer communication device 104.

In accordance with at least some embodiments of the present disclosure, the work item is sent toward a collection of processing resources 712 via the combined efforts of the work assignment mechanism 716 and routing engine 732. The resources 712 can either be completely automated resources (e.g., Interactive Voice Response (IVR) units, microprocessors, servers, or the like), human resources utilizing communication devices (e.g., human agents utilizing a computer, telephone, laptop, etc.), or any other resource known to be used in contact center 702.

As discussed above, the work assignment mechanism 716 and resources 712 may be owned and operated by a common entity in a contact center 702 format. In some embodiments, the work assignment mechanism 716 may be administered by multiple enterprises, each of which has its own dedicated resources 712 connected to the work assignment mechanism 716.

In some embodiments, the work assignment mechanism 716 comprises a work assignment engine 720, which enables the work assignment mechanism 716 to make intelligent routing decisions for work items. In some embodiments, the work assignment engine 720 is configured to administer and make work assignment decisions in a queueless contact center 702, as is described in U.S. patent application Ser. No. 12/882,950, the entire contents of which are hereby incorporated herein by reference. In other embodiments, the work assignment engine 720 may be configured to execute work assignment decisions in a traditional queue-based (or skill-based) contact center 702.

The work assignment engine 720 and its various components may reside in the work assignment mechanism 716 or in a number of different servers or processing devices. In some embodiments, cloud-based computing architectures can be employed whereby one or more hardware components of the work assignment mechanism 716 are made available in a cloud or network such that they can be shared resources among a plurality of different users. Work assignment mechanism 716 may access customer database 718, such as to retrieve records, profiles, purchase history, previous work items, and/or other aspects of a customer known to contact center 702. Customer database 718 may be updated in response to a work item and/or input from resource 712 processing the work item.

It should be appreciated that one or more components of contact center 702 may be implemented in a cloud-based architecture in their entirety, or components thereof (e.g., hybrid), in addition to embodiments being entirely on-premises. In one embodiment, customer communication device 104 is connected to one of resources 712 via components entirely hosted by a cloud-based service provider, wherein processing and data storage hardware components may be dedicated to the operator of contact center 702 or shared or distributed amongst a plurality of service provider customers, one being contact center 702.

In one embodiment, a message is generated by customer communication device 104 and received, via communication network 704, at work assignment mechanism 716. The message received by a contact center 702, such as at the work assignment mechanism 716, is generally, and herein, referred to as a “contact.” Routing engine 732 routes the contact to at least one of resources 712 for processing.

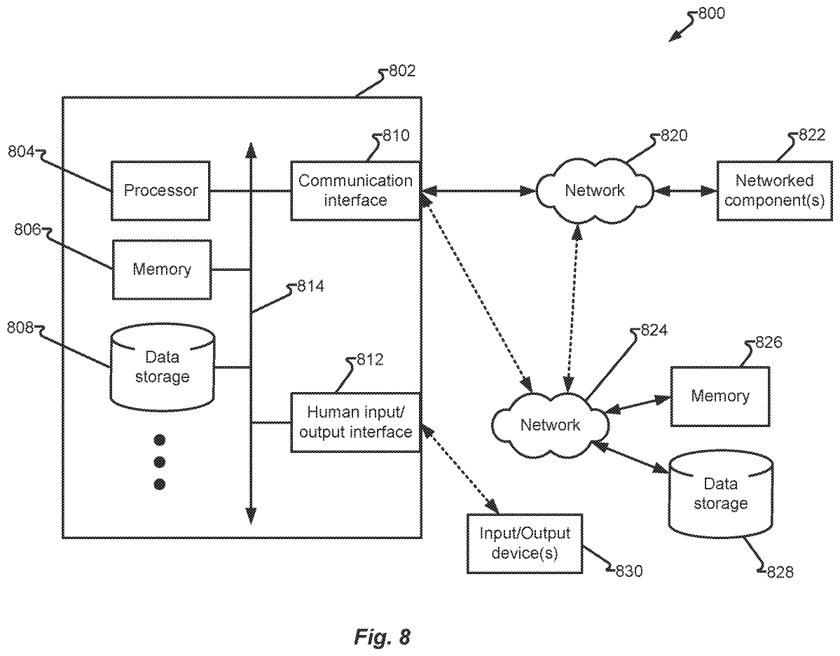

FIG. 8 depicts device 802 in system 800 in accordance with embodiments of the present disclosure. In one embodiment, automatic call director 110, server 206, and server 306 may each be embodied, in whole or in part, as device 802 comprising various components and connections to other components and/or systems. The components are variously embodied and may comprise processor 804. The term “processor,” as used herein, refers exclusively to electronic hardware components comprising electrical circuitry with connections (e.g., pin-outs) to convey encoded electrical signals to and from the electrical circuitry. Processor 804 may be further embodied as a single electronic microprocessor or multiprocessor device (e.g., multicore) having electrical circuitry therein which may further comprise a control unit(s), input/output unit(s), arithmetic logic unit(s), register(s), primary memory, and/or other components that access information (e.g., data, instructions, etc.), such as received via bus 814, executes instructions, and outputs data, again such as via bus 814. In other embodiments, processor 804 may comprise a shared processing device that may be utilized by other processes and/or process owners, such as in a processing array within a system (e.g., blade, multi-processor board, etc.) or distributed processing system (e.g., “cloud”, farm, etc.). It should be appreciated that processor 804 is a non-transitory computing device (e.g., electronic machine comprising circuitry and connections to communicate with other components and devices). Processor 804 may operate a virtual processor, such as to process machine instructions not native to the processor (e.g., translate the VAX operating system and VAX machine instruction code set into Intel® 9xx chipset code to enable VAX-specific applications to execute on a virtual VAX processor), however, as those of ordinary skill understand, such virtual processors are applications executed by hardware, more specifically, the underlying electrical circuitry and other hardware of the processor (e.g., processor 804). Processor 804 may be executed by virtual processors, such as when applications (i.e., Pod) are orchestrated by Kubernetes. Virtual processors enable an application to be presented with what appears to be a static and/or dedicated processor executing the instructions of the application, while underlying non-virtual processor(s) are executing the instructions and may be dynamic and/or split among a number of processors.

In addition to the components of processor 804, device 802 may utilize memory 806 and/or data storage 808 for the storage of accessible data, such as instructions, values, etc. Communication interface 810 facilitates communication with components, such as processor 804 via bus 814 with components not accessible via bus 814. Communication interface 810 may be embodied as a network port, card, cable, or other configured hardware device. Additionally or alternatively, human input/output interface 812 connects to one or more interface components to receive and/or present information (e.g., instructions, data, values, etc.) to and/or from a human and/or electronic device. Examples of input/output devices 830 that may be connected to input/output interface include, but are not limited to, keyboard, mouse, trackball, printers, displays, sensor, switch, relay, speaker, microphone, still and/or video camera, etc. In another embodiment, communication interface 810 may comprise, or be comprised by, human input/output interface 812. Communication interface 810 may be configured to communicate directly with a networked component or utilize one or more networks, such as network 820 and/or network 824.

Network 106 may be embodied, in whole or in part, as network 820. Network 820 may be a wired network (e.g., Ethernet), wireless (e.g., Wi-Fi, Bluetooth, cellular, etc.) network, or combination thereof and enable device 802 to communicate with networked component(s) 822. In other embodiments, network 820 may be embodied, in whole or in part, as a telephony network (e.g., public switched telephone network (PSTN), private branch exchange (PBX), cellular telephony network, etc.)

Additionally or alternatively, one or more other networks may be utilized. For example, network 824 may represent a second network, which may facilitate communication with components utilized by device 802. For example, network 824 may be an internal network to a business entity or other organization, such as contact center 702, whereby components are trusted (or at least more so) that networked components 822, which may be connected to network 820 comprising a public network (e.g., Internet) that may not be as trusted.

Components attached to network 824 may include memory 826, data storage 828, input/output device(s) 830, and/or other components that may be accessible to processor 804. For example, memory 826 and/or data storage 828 may supplement or supplant memory 806 and/or data storage 808 entirely or for a particular task or purpose. For example, memory 826 and/or data storage 828 may be an external data repository (e.g., server farm, array, “cloud,” etc.) and enable device 802, and/or other devices, to access data thereon. Similarly, input/output device(s) 830 may be accessed by processor 804 via human input/output interface 812 and/or via communication interface 810 either directly, via network 824, via network 820 alone (not shown), or via networks 824 and 820. Each of memory 806, data storage 808, memory 826, data storage 828 comprise a non-transitory data storage comprising a data storage device.

It should be appreciated that computer readable data may be sent, received, stored, processed, and presented by a variety of components. It should also be appreciated that components illustrated may control other components, whether illustrated herein or otherwise. For example, one input/output device 830 may be a router, switch, port, or other communication component such that a particular output of processor 804 enables (or disables) input/output device 830, which may be associated with network 820 and/or network 824, to allow (or disallow) communications between two or more nodes on network 820 and/or network 824. For example, a connection between one particular customer, using a particular customer communication device 104, may be enabled (or disabled) with a particular networked component 822 and/or particular resource 712. Similarly, one particular networked component 822 and/or resource 712 may be enabled (or disabled) from communicating with a particular other networked component 822 and/or resource 712, including, in certain embodiments, device 802 or vice versa. One of ordinary skill in the art will appreciate that other communication equipment may be utilized, in addition or as an alternative, to those described herein without departing from the scope of the embodiments.

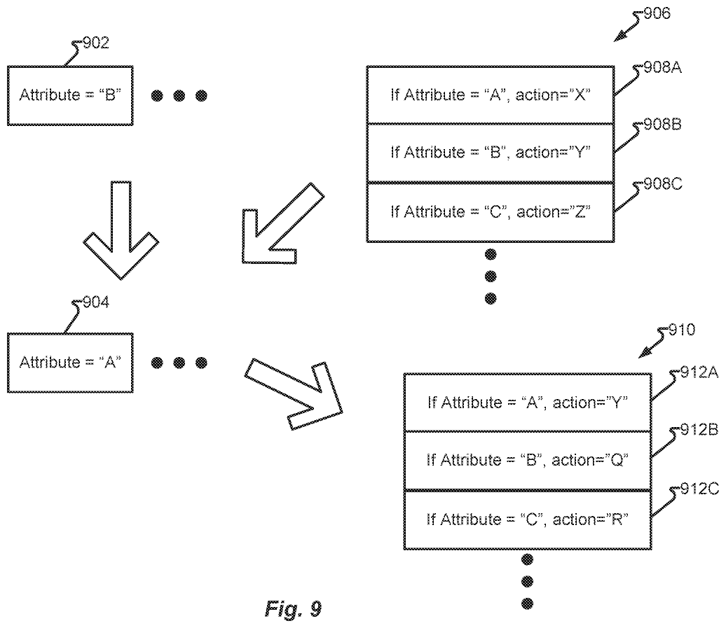

FIG. 9 depicts raw data structure 902 and modified data structure 904 in accordance with embodiments of the present disclosure. In one embodiment, raw data structure 902 comprises at least one field having therein the value of an attribute. A processor, such as a processor of one of AI-based decision component 108 or algorithmic-based decision component 112, accesses raw data structure 902 which comprises at least one attribute field, and may optionally comprise additional attribute fields and/or additional fields utilized for other purposes.

The processor maps raw data structure 902 to a command, such as command 908A of mapping 906, such as to associate a particular action (e.g., action “X”) as resulting from a particular value of the attribute (e.g., Attribute “B”). From mapping 906, modified data structure 904 is produced, such as to cause mapping 910, which is utilized for decision making by the other one of AI-based decision component 108 or algorithmic-based decision component 112, to select a particular action. As a result, the processor of the one of the AI-based decision component 108 or algorithmic-based decision component 112 automatically reconfigures the processor of the other one of the of AI-based decision component 108 or algorithmic-based decision component 112, which is performed automatically and without human intervention.

For example, if the processor of one of one of AI-based decision component 108 or algorithmic-based decision component 112 performs operation “Y” 908B, when the attribute of raw data structure 902 is “B”. The processor then utilizes mapping 906 to create modified data structure 904, such as to have a different value (e.g., “A”), from the value of the attribute in raw data structure 902. The value in data structure 904 then being selected to cause mapping 910 to evaluate the attribute of data structure 904 differently. For example, command 912A will be evaluated and thereby cause the same resulting action, namely action “Y” of command 912A, as opposed to action “Q” of command 912B had the value remained “B”.

In the foregoing description, for the purposes of illustration, methods were described in a particular order. It should be appreciated that in alternate embodiments, the methods may be performed in a different order than that described without departing from the scope of the embodiments. It should also be appreciated that the methods described above may be performed as algorithms executed by hardware components (e.g., circuitry) purpose-built to carry out one or more algorithms or portions thereof described herein. In another embodiment, the hardware component may comprise a general-purpose microprocessor (e.g., CPU, GPU) that is first converted to a special-purpose microprocessor. The special-purpose microprocessor then having had loaded therein encoded signals causing the, now special-purpose, microprocessor to maintain machine-readable instructions to enable the microprocessor to read and execute the machine-readable set of instructions derived from the algorithms and/or other instructions described herein. The machine-readable instructions utilized to execute the algorithm(s), or portions thereof, are not unlimited but utilize a finite set of instructions known to the microprocessor. The machine-readable instructions may be encoded in the microprocessor as signals or values in signal-producing components and included, in one or more embodiments, voltages in memory circuits, configuration of switching circuits, and/or by selective use of particular logic gate circuits. Additionally or alternative, the machine-readable instructions may be accessible to the microprocessor and encoded in a media or device as magnetic fields, voltage values, charge values, reflective/non-reflective portions, and/or physical indicia.

In another embodiment, the microprocessor further comprises one or more of a single microprocessor, a multi-core processor, a plurality of microprocessors, a distributed processing system (e.g., array(s), blade(s), server farm(s), “cloud”, multi-purpose processor array(s), cluster(s), etc.) and/or may be co-located with a microprocessor performing other processing operations. Any one or more microprocessor may be integrated into a single processing appliance (e.g., computer, server, blade, etc.) or located entirely or in part in a discrete component connected via a communications link (e.g., bus, network, backplane, etc. or a plurality thereof).

Examples of general-purpose microprocessors may comprise, a central processing unit (CPU) with data values encoded in an instruction register (or other circuitry maintaining instructions) or data values comprising memory locations, which in turn comprise values utilized as instructions. The memory locations may further comprise a memory location that is external to the CPU. Such CPU-external components may be embodied as one or more of a field-programmable gate array (FPGA), read-only memory (ROM), programmable read-only memory (PROM), erasable programmable read-only memory (EPROM), random access memory (RAM), bus-accessible storage, network-accessible storage, etc.

These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

In another embodiment, a microprocessor may be a system or collection of processing hardware components, such as a microprocessor on a client device and a microprocessor on a server, a collection of devices with their respective microprocessor, or a shared or remote processing service (e.g., “cloud” based microprocessor). A system of microprocessors may comprise task-specific allocation of processing tasks and/or shared or distributed processing tasks. In yet another embodiment, a microprocessor may execute software to provide the services to emulate a different microprocessor or microprocessors. As a result, first microprocessor, comprised of a first set of hardware components, may virtually provide the services of a second microprocessor whereby the hardware associated with the first microprocessor may operate using an instruction set associated with the second microprocessor.

While machine-executable instructions may be stored and executed locally to a particular machine (e.g., personal computer, mobile computing device, laptop, etc.), it should be appreciated that the storage of data and/or instructions and/or the execution of at least a portion of the instructions may be provided via connectivity to a remote data storage and/or processing device or collection of devices, commonly known as “the cloud,” but may include a public, private, dedicated, shared and/or other service bureau, computing service, and/or “server farm.”

Examples of the microprocessors as described herein may include, but are not limited to, at least one of Qualcomm® Snapdragon® 800 and 801, Qualcomm® Snapdragon® 610 and 615 with 4G LTE Integration and 64-bit computing, Apple® A7 microprocessor with 64-bit architecture, Apple® M7 motion comicroprocessors, Samsung® Exynos® series, the Intel® Core™ family of microprocessors, the Intel® Xeon® family of microprocessors, the Intel® Atom™ family of microprocessors, the Intel Itanium® family of microprocessors, Intel® Core® i5-4670K and i7-4770K 22 nm Haswell, Intel® Core® i5-3570K 22 nm Ivy Bridge, the AMD® FX™ family of microprocessors, AMD® FX-4300, FX-6300, and FX-8350 32 nm Vishera, AMD® Kaveri microprocessors, Texas Instruments® Jacinto C6000™ automotive infotainment microprocessors, Texas Instruments® OMAP™ automotive-grade mobile microprocessors, ARM® Cortex™-M microprocessors, ARM® Cortex-A and ARM926EJ-S™ microprocessors, other industry-equivalent microprocessors, and may perform computational functions using any known or future-developed standard, instruction set, libraries, and/or architecture.

Any of the steps, functions, and operations discussed herein can be performed continuously and automatically.

The exemplary systems and methods of this invention have been described in relation to communications systems and components and methods for monitoring, enhancing, and embellishing communications and messages. However, to avoid unnecessarily obscuring the present invention, the preceding description omits a number of known structures and devices. This omission is not to be construed as a limitation of the scope of the claimed invention. Specific details are set forth to provide an understanding of the present invention. It should, however, be appreciated that the present invention may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components or portions thereof (e.g., microprocessors, memory/storage, interfaces, etc.) of the system can be combined into one or more devices, such as a server, servers, computer, computing device, terminal, “cloud” or other distributed processing, or collocated on a particular node of a distributed network, such as an analog and/or digital telecommunications network, a packet-switched network, or a circuit-switched network. In another embodiment, the components may be physical or logically distributed across a plurality of components (e.g., a microprocessor may comprise a first microprocessor on one component and a second microprocessor on another component, each performing a portion of a shared task and/or an allocated task). It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the invention.

A number of variations and modifications of the invention can be used. It would be possible to provide for some features of the invention without providing others.

In yet another embodiment, the systems and methods of this invention can be implemented in conjunction with a special purpose computer, a programmed microprocessor or microcontroller and peripheral integrated circuit element(s), an ASIC or other integrated circuit, a digital signal microprocessor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this invention. Exemplary hardware that can be used for the present invention includes computers, handheld devices, telephones (e.g., cellular, Internet enabled, digital, analog, hybrids, and others), and other hardware known in the art. Some of these devices include microprocessors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein as provided by one or more processing components.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this invention can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Embodiments herein comprising software are executed, or stored for subsequent execution, by one or more microprocessors and are executed as executable code. The executable code being selected to execute instructions that comprise the particular embodiment. The instructions executed being a constrained set of instructions selected from the discrete set of native instructions understood by the microprocessor and, prior to execution, committed to microprocessor-accessible memory. In another embodiment, human-readable “source code” software, prior to execution by the one or more microprocessors, is first converted to system software to comprise a platform (e.g., computer, microprocessor, database, etc.) specific set of instructions selected from the platform's native instruction set.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, configurations, and aspects, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments, configurations, or aspects for the purpose of streamlining the disclosure. The features of the embodiments, configurations, or aspects of the invention may be combined in alternate embodiments, configurations, or aspects other than those discussed above. This method of disclosure is not to be interpreted as reflecting an intention that the claimed invention requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the invention.

Moreover, though the description of the invention has included description of one or more embodiments, configurations, or aspects and certain variations and modifications, other variations, combinations, and modifications are within the scope of the invention, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A method for configuring a multiple decision components of a system utilized to match specific users of a number of users to a specific agent of a number of agents, comprising:
receiving, by a processor, a raw modification data structure comprising an attribute utilized by each of a first decision component and a second decision component, each being a portion of the multiple decision components;
determining, by the processor, a first mapping of the attribute to a command of the first decision component;
generating, by the processor, a first modified data structure from the first mapping;
providing, by the processor, the first modified data structure to the first decision component, to cause at least at least one user of the specific users to be matched to a different specific agent of the number of agents as compared to a match that would have occurred prior to providing the first modified data structure to the first decision component;
determining, by the processor, a second mapping of the attribute to a command of the second decision component;
generating, by the processor, a second modified data structure from the second mapping; and
providing, by the processor, the second modified data structure to the second decision component, to cause at least at least one user of the specific users to be matched to a different specific agent of the number of agents as compared to a match that would have occurred prior to providing the second modified data structure to the second decision component.

2. The method of claim 1, further comprising:
receiving, by the processor, a communication via a network of a first user of the number of users;
obtaining attributes of at least one of the first user and a reason for the communication;
providing the attributes to a selected one of the first decision component or the second decision component;
receiving from the selected one of the first decision component or the second decision component, a matching decision selecting a first agent of the number of agents; and
altering, by the processor, a network topology to connect a communication device associated with the first agent to a user device utilized by the first user for communication via the network.

3. The method of claim 2, further comprising:
receiving, by the processor and from the first decision component, a first record comprising an analytic data structure comprising a rationale utilized in determining the matching decision from the selected one of the first decision component or the second decision component providing the matching decision.

4. The method of claim 3, further comprising, upon the selected one of the first decision component or the second decision component being the first decision component, generating, by the processor, the second modified data structure to further comprise the rationale.

5. The method of claim 3, further comprising, upon the selected one of the first decision component or the second decision component being the second decision component, generating, by the processor, the first modified data structure to further comprise the rationale.

6. The method of claim 3, wherein the analytic data structure comprises at least one field indicating at least one of an error, an event, or an aggregated event report.

7. The method of claim 1, wherein:
providing the attributes to the selected one of the first decision component or the second decision component, further comprises providing the attributes to both the first decision component and the second decision component; and
receiving from the selected one of the first decision component or the second decision component, the matching decision selecting a first agent of the number of agents, further comprises receiving the matching decision from the first decision component or the second decision component that is first to respond with the matching decision.

8. The method of claim 1 wherein the agent is an automated agent.

9. The method of claim 1 wherein the agent is an agent queue for a set of agents.

10. A system for configuring multiple decision components of a system utilized to match specific users of a number of users to a specific agent of a number of agents, comprising:
a processor, comprising at least one microprocessors having instructions maintained in a non-transitory memory for execution by the processor;
an interface to a network; and
wherein the processor:
receives a raw modification data structure comprising an attribute utilized by each of a first decision component and a second decision component, each being a portion of the multiple decision components;
determines, a first mapping of the attribute to a command of the first decision component;
generates a first modified data structure from the first mapping;
provides the first modified data structure to the first decision component, to cause at least at least one user of the specific users to be matched to a different specific agent of the number of agents as compared to a match that would have occurred prior to providing the first modified data structure to the first decision component;
determines a second mapping of the attribute to a command of the second decision component;
generates a second modified data structure from the second mapping; and
provides the second modified data structure to the second decision component, to cause at least at least one user of the specific users to be matched to a different specific agent of the number of agents as compared to a match that would have occurred prior to providing the second modified data structure to the second decision component.

11. The system of claim 10, wherein the processor further:
receives a communication via a network of a first user of the number of users;
obtains at least one of the first user and a reason for the communication;
provides the attributes to a selected one of the first decision component or the second decision component;
receives from the selected one of the first decision component or the second decision component, a matching decision selecting a first agent of the number of agents; and
alters a network topology to connect a communication device associated with the first agent to a user device utilized by the first user for communication via the network.

12. The system of claim 11, wherein the processor further:
receives, by the processor and from the first decision component, a first record comprising an analytic data structure comprising a rationale utilized in determining the matching decision from the selected one of the first decision component or the second decision component providing the matching decision.

13. The system of claim 12, wherein upon the selected one of the first decision component or the second decision component is the first decision component, the processor further generates, the second modified data structure to further comprise the rationale.

14. The system of claim 12, wherein upon the selected one of the first decision component or the second decision component is the second decision component, the processor further generate the first modified data structure to further comprise the rationale.

15. The system of claim 12, wherein the analytic data structure comprises at least one field indicating at least one of an error, an event, or an aggregated event report.

16. The system of claim 10, wherein the processor:
provides the attributes to the selected one of the first decision component or the second decision component, further comprising providing the attributes to both the first decision component and the second decision component; and
receives from the selected one of the first decision component or the second decision component, the matching decision selecting a first agent of the number of agents, further comprising receiving the matching decision from the first decision component or the second decision component that is first to respond with the matching decision.

17. The system of claim 10 wherein the agent is an automated agent.

18. The system of claim 10 wherein the agent is an agent queue for a set of agents.

19. A system for configuring a multiple decision components of a system utilized to match specific users of a number of users to a specific agent of a number of agents, comprising:
means to receive a raw modification data structure comprising an attribute utilized by each of a first decision component and a second decision component, each being a portion of the multiple decision components;
means to determine a first mapping of the attribute to a command of the first decision component;
means to generate a first modified data structure from the first mapping;
means to provide the first modified data structure to the first decision component, to cause at least at least one user of the specific users to be matched to a different specific agent of the number of agents as compared to a match that would have occurred prior to providing the first modified data structure to the first decision component;
means to determine a second mapping of the attribute to a command of the second decision component;
means to generate a second modified data structure from the second mapping; and
means to provide the second modified data structure to the second decision component, to cause at least at least one user of the specific users to be matched to a different specific agent of the number of agents as compared to a match that would have occurred prior to providing the second modified data structure to the second decision component.

20. The system of claim 19, further comprising:
means to receive a communication via a network of a first user of the number of users;
means to obtain attributes of at least one of the first user and a reason for the communication;
means to provide the attributes to a selected one of the first decision component or the second decision component;
means to receive from the selected one of the first decision component or the second decision component, a matching decision selecting a first agent of the number of agents;
means to alter a network topology to connect a communication device associated with the first agent to a user device utilized by the first user for communication via the network.
